(19) United States
(12) Patent Application Publication
(10) Pub. No.: US 2011/0032557 A1
(43) Pub. Date: Feb. 10, 2011

(54) PRINTING

(76) Inventors: Moisey Bernstein, Rishon LeTzion (IL); Arik Zuria, Avaz Kiryat-Gat (IL); Tsahi Rosenbaom, Rishon le zion (IL); Boris Weinstein, Ness Ziona Rehovot (IL)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/937,683

(22) PCT Filed: Apr. 28, 2009
(86) PCT No.: PCT/US09/41921

§ 371 Date: Oct. 13, 2010

(30) Foreign Application Priority Data
Apr. 30, 2008 (GB) 0807833.9

(51) Int. Cl. G06K 15/00; B41F 33/00

(52) U.S. Cl. 358/1.12; 101/483

(57) ABSTRACT

A method of printing on both sides of a substrate (20) comprising checking the relative positions of images on the front and back of the printed substrate (20) by capturing an image (100, 100) of markings (60, 62, 50, 52) on the front and back by imaging the printed substrate (20) from one side only, the markings on the back (60, 62) being seen through the material of the substrate (20).

An embodiment of the invention provides a method comprising: printing on both sides of a sheet with a printer; generating an image from one side of the sheet; image processing the image, the processing comprising comparing the position of a section of the image originating from one side of the sheet with the position of a section of the image originating from the other side of the sheet; and altering parameters of the printer in response to said image processing.

The image may be obtained by using front lighting only, front and back lighting, or back lighting only. The type of lighting used can, in some cases, be determined by the configuration of the printer.

An embodiment of the invention provides a method of calibrating a printer comprising: capturing an image from one side of a print medium, the print medium supporting print on both sides; determining from said captured image the relative position of a feature printed one side of the print medium with a feature printed on the other side of the print medium; comparing the determined relative position with an expected or predetermined relative position; and calibrating the printer in response to said comparison.

For some embodiments of the invention calibration is not part of the method and the method involves merely providing a measure of the relative positions of the images printed on either side of the print medium. For example, the method may provide a user with a parameter so that the user can adjust/calibrate the printer based on the parameter. In some embodiments the captured image is displayed and a user may then adjust the printer after checking the alignment of the printed features captured in the displayed image. In yet other embodiments the calibration is performed automatically without intervention by a user.

An embodiment of the invention provides a method of processing image data obtained by imaging an image bearing substrate, the image data comprising front image data from an image on a front side of the image bearing substrate and show-through image data from an image on the back side of the image bearing substrate, wherein the processing comprises determining the relative positions of the front side image, or a portion thereof, and the show-through image, or a portion thereof.

The processing may comprise generating an alignment factor in response to said determination for use with alignment of print on the front and back of a print medium in a subsequent printing operation.

An embodiment of the invention provides a computer-implemented method comprising: capturing with an imager an image from one side of a printed sheet having print on both sides of the sheet, the image containing content from a first side of the printed sheet and also from the opposite, second, side of the printed sheet; and comparing the position of a section of the image originating from the first side of the printed sheet with the position of a section of the image originating from the second side of the printed sheet. Such a method may comprise a method of printing and comprise adjusting, in a subsequent printing operation, the position of print on a sheet in response to said comparison. For example, said adjusting may comprise adjusting the relative position of printed content on one side of the sheet compared with the position of printed content on the other side of the sheet. In some embodiments the imager is inside the printer that produces the printed sheet or otherwise captures images from the printed sheet whilst the printed sheet is within the printer.

Embodiments of the invention will now be described by way of example with reference to the accompanying drawings:

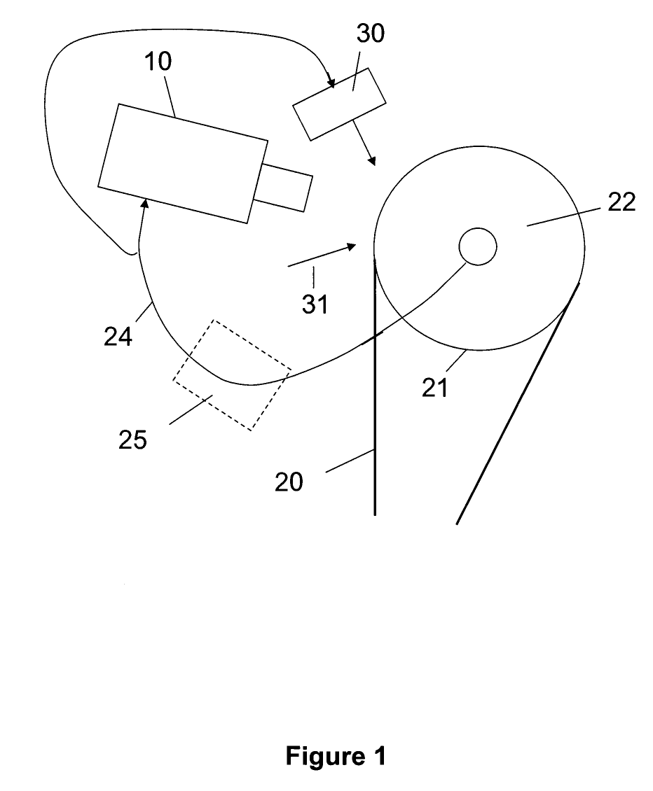

FIG. 1 illustrates a system according to an embodiment of the invention;

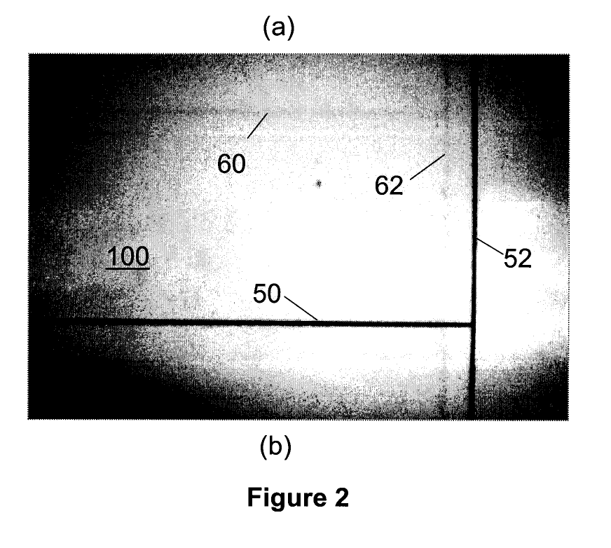

FIG. 2 illustrates images of a print medium according to an embodiment of the invention;

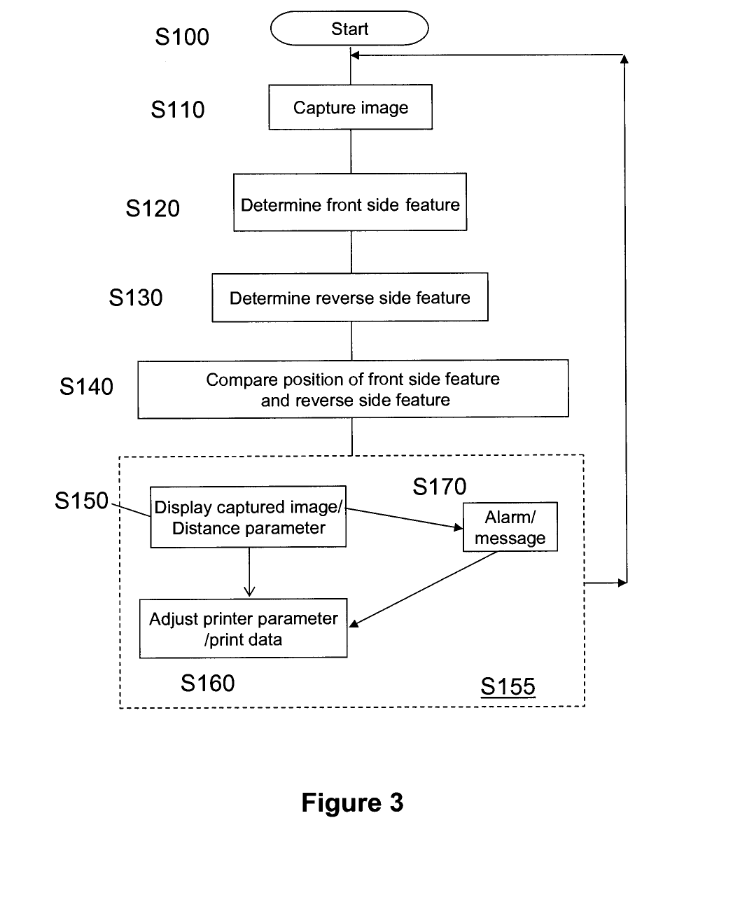

FIG. 3 is a flow diagram according to an embodiment of the invention;

FIG. 3a is a schematic diagram of the image illustrated in FIG. 2;

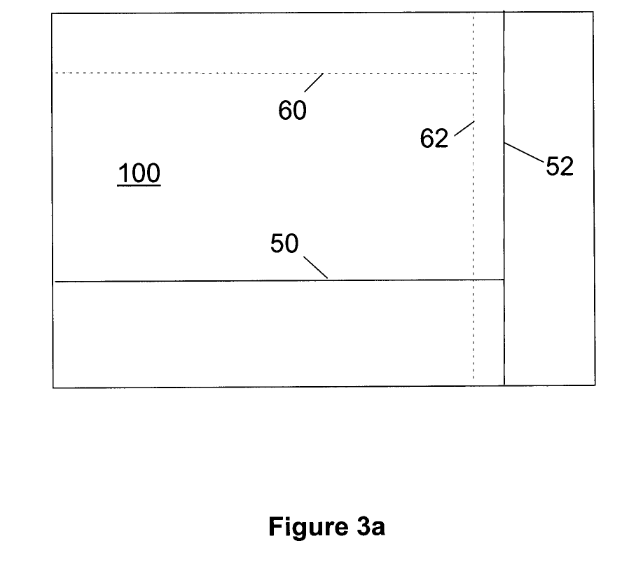

FIG. 4 is a display illustrating processing of a captured image according to an embodiment of the invention;

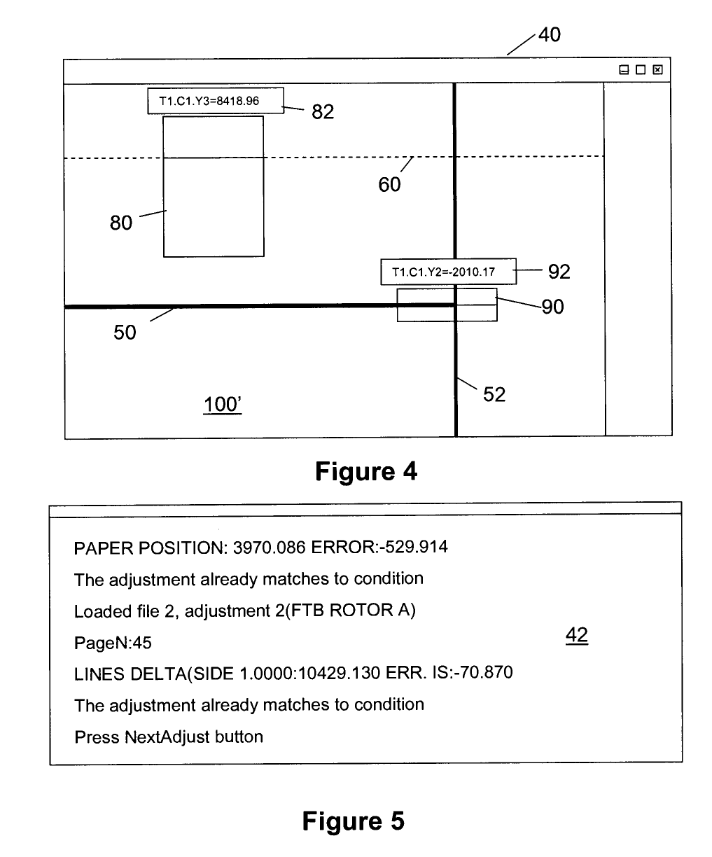

FIG. 5 is a display illustrating processing according to an embodiment of the invention;

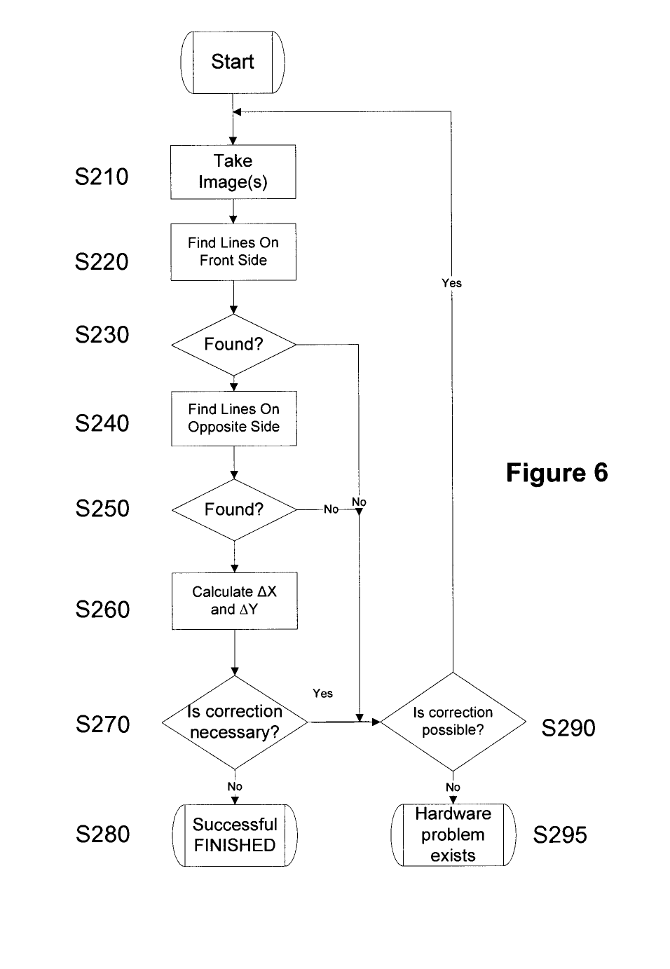

FIG. 6 is a flow diagram according to an embodiment of the invention;

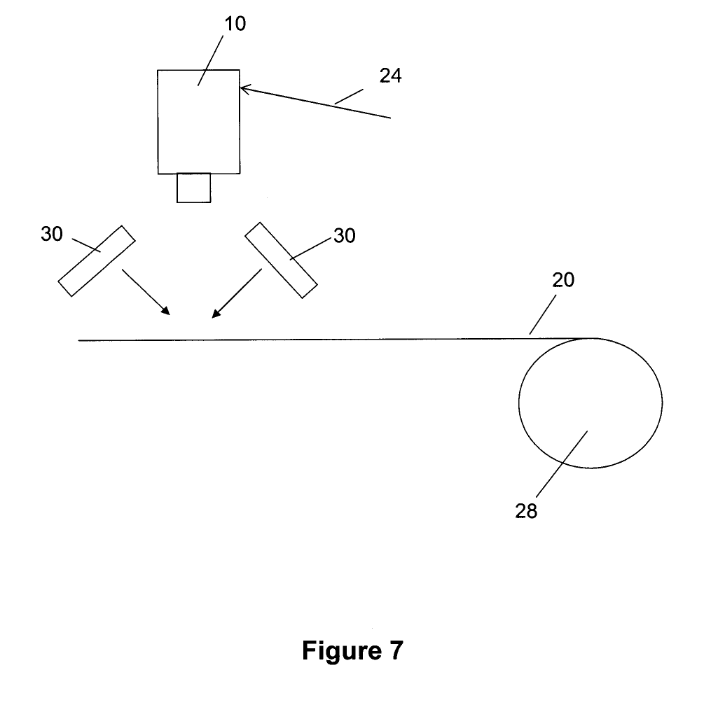

FIG. 7 illustrates a system for capturing an image of a substrate according to an embodiment of the invention;

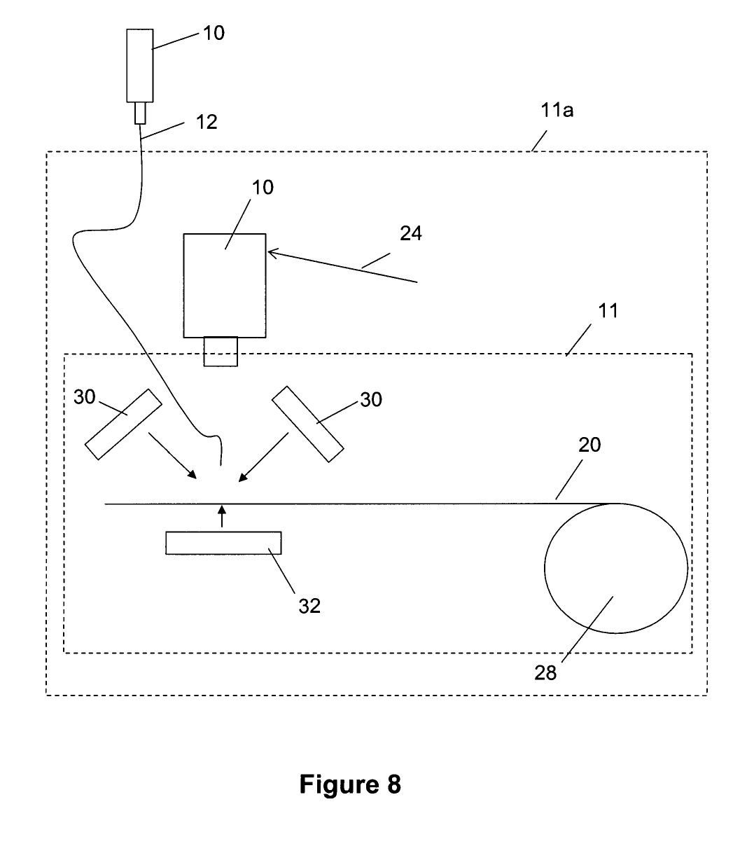

FIG. 8 illustrates a system for capturing an image of a substrate using backlighting according to an embodiment of the invention; and

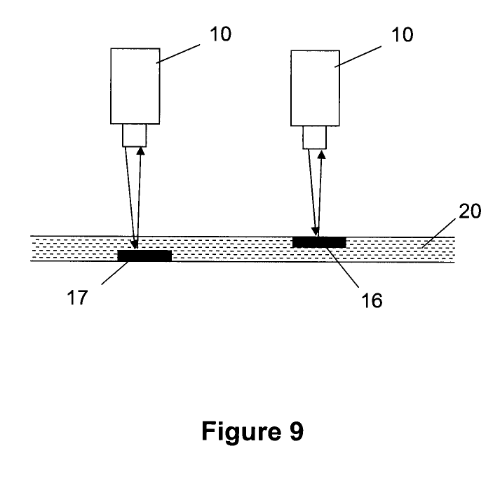

FIG. 9 illustrates a system for capturing an image of a substrate according to an embodiment of the invention

The translucent nature of a print medium such as paper can cause problems in many applications. For example, it is common that when a sheet of newspaper is photocopied the photocopy will have both an image of the side of the sheet that was intended to be copied and a fainter, low-contrast, image (a so-called “ghost image”) of the reverse side of the sheet. This effect is commonly referred to as “show-through”.

Embodiments of the present invention make use of show-through as a means to monitor the relative positions of print printed on the front side and the opposite, reverse, side of a sheet of print medium (as may occur, for example, in duplex or double-sided printing). Embodiments of the invention enable the determination of the relative positions of front and back images to check or adjust the alignment of a printer that produced the print on the medium. Some embodiments check that images printed on one side of the print medium do not overlap, or substantially overlap, with printed images showing through from the reverse side of the medium and adjust the printer appropriately.

Embodiments of the invention are not limited to the use of paper as the print medium and the invention is applicable to other print media and substrates in which show-through can be used (for example plastic substrates, thin foils, substrates with watermarks etc.)

FIG. 1 illustrates a system for obtaining one or more images of a print medium 20 according to an embodiment of the invention. The images may be used to determine the alignment of the print on the print medium 20, for example the alignment of the print on one side of the print medium 20 with the print on the other side of the print medium 20.

In the particular embodiment illustrated in FIG. 1 an imager 10 is arranged to take an image of the print medium 20 when the print medium 20 is supported by a transport mechanism which is part of a printer such as, for example, an impression drum 22. Since the print medium 20 is supported by the impression drum 22 there is access to only one side of the print medium 20 to capture an image of the medium (i.e. the side of the print medium 20 that faces the imager 10 and, in this case, faces away from the impression drum 22). The imager 10 may typically be an optical sensor such as, for example, a CCD (charge-coupled device) array or CMOS (complementary metal oxide semiconductor) array. The function of the imager 10 is to obtain images in which features printed on both sides of the print medium can be identified and the imager 10 is not necessarily limited to the optical region of the electromagnetic spectrum.

FIG. 2(a) illustrates an image 100 captured by the two dimensional imager 10 (in this case an optical camera) which shows a horizontal line 50 and a vertical line 52 which originated from the print on “front” side of the print medium 20 (i.e. the side facing the camera). Also in the image are show-through horizontal line 60 and show-through vertical line 62 which originated from the opposite (reverse) side of the print medium. These show-through lines 60, 62 are of lower contrast in the captured image than the lines originating from the front side of the print medium 20. The show-through lines 60, 62 have been marked with dotted lines in FIG. 2(a) so that they are more readily discernible. FIG. 2(b) is of the same image 100 but, for the purposes of clarity of presentation for this specification, with the contrast of the image 100 increased by use of proprietary software. FIG. 3a is schematic of FIG. 2 whilst FIG. 4 is a representation 100′ of the captured image 100 on a computer screen or other display.

Referring again to FIG. 1, ambient lighting 31 may be sufficient to obtain an image of the print medium 20 or one or more light sources 30 (optical or otherwise) may be directed at the print medium 20 to improve the quality of the captured image 100. The light source 30 may be part of an imager/camera 10 or connected to the imager 10. In the cases when the print medium moves in front of the imager the light source 30 may produces a flash which is synchronised with the imager exposure so that bright light is directed at the print medium 20 when an image is taken. A stroboscopic flash light could be synchronised with the motion of the print medium to enable capturing of the necessary print details. Connection 24 between the impression drum encoder, camera and light source(s) can provide such synchronization. A synchronisation controller 25 could be used in cases when the imager and lighting system do not have internal circuits for encoder input. The light accumulation time (i.e. the time overlap between the exposure time and the lighting time) is dependent on the speed of the substrate and should be small enough to obtain good image contrast without blurring the captured image.

When a specific light source 30 is used to illuminate the print medium 20 the light source 30 may be configured to produce a non-uniform light spectrum to improve the contrast of the image. Some substrates (for example some plastics) are more transparent for infrared light than visible light and this property can be used to increase the contrast of the reverse side image obtained by choice of the spectrum of the illumination. Various colours/wavelength spectra can also be used for the illumination of the print medium according to the colour of the printed image elements on the print substrate. For example an LED with a powerful blue component increases contrast (compared to, say, a white LED with a lower blue component) of a yellow line, or other image element, printed on the substrate.

The imager 10, in some embodiments, is synchronised with the movement of the print medium 20 so that an image of a predetermined section of the print medium 20 is captured. For example, the imager 10 may be controlled to take an image of the medium 20 when particular, predetermined, printed content on the medium 20 comes into view of the imager 10. The operation of the imager 10 may be synchronised by, for example, using a signal 24 obtained from a transport mechanism for the medium (eg from the impression drum 22) or from some other part of the printer. In a similar manner the lighting 30 may also be synchronised with the movement of the print medium 20 so that the lighting produces a flash whilst the imager 10 is obtaining an image. The lighting 30 may be synchronised with the imager 10 or via a signal directly from the printer.

FIG. 3 is a flow diagram that illustrates a process according to an embodiment of the invention. Not all of the steps illustrated in the flow diagram are required for all embodiments of the invention. Furthermore, some embodiments may have the steps in a different order than that illustrated (for example the order of steps S120 and S130 may be reversed as described below).

At step S100 the process starts by, for example, a signal or instruction to take an image 100. The signal may be a synchronisation signal as described above. An instruction to take an image 100 may also be given without use of a synchronisation signal, for example, a user may activate the camera to take one or more images at an appropriate time.

At step S110 the imager 10 captures an image 100 of the print medium 20. The captured image may then undergo image processing. FIG. 4 is a representation of a display screen 40 in which part of the captured image 100 is shown together with some graphical elements 80, 82, 90, 92 produced by image processing the captured image 100 (as described in more detail below).

At step S120 the captured image is analysed and a feature of the captured image that originates from the front of the print medium (“front side feature”) is identified. Similarly, at step S130 a feature of the captured image that originates from the reverse of the print medium (“reverse side feature”) is identified. The order of steps S120 and S130 is not important and the reverse side feature could be identified before or concurrently with the identification of the front side feature.

Referring to FIG. 4, the image processing has identified a horizontal line 50 and a vertical line 52 originating from the front side of the print medium 20 and a horizontal line 60 which is caused by show-through from the reverse side of the print medium 20. Feature detection and recognition could be done by standard image processing methods. Feature identification could be achieved using the position of the feature since each feature should be in some known position relative to other features, i.e. all printed features should form known patterns on both sides of the medium. According to an embodiment of the invention this pattern should be constructed in such a way that features on both sides of the print medium should not be overlapped in the captured image.

At step S140 a comparison is made of the positions of an identified front side feature and the position of an identified reverse side feature. In some embodiments the distance between these features may be calculated/measured for example using the coordinates of the features. In some embodiments the position of a printed feature is measured with reference to some other feature of the captured image such as, for example an edge of the print medium may form part of the captured image.

At step S150 one or more parameters that give the positions of the features or the relative positions may be displayed. In the example shown in FIG. 4 the Y-coordinate of the horizontal lines 60 and 50 are displayed. At step S150 the captured image 100 may also be displayed, for example as shown in FIG. 2, or a representation 100′ thereof as shown, for example, in FIGS. 3a. The captured image 100 (or a representative 100′ thereof) may be displayed instead of or as well as displaying parameters of the positions of the features. The display illustrated in FIG. 4 shows measurement parameters and image features in the same display 40 but the parameters and image features could be displayed separately, for example as different portions of a display on the same screen, as displays on separate screens, or as displays on the same screen at different times. It should be appreciated that embodiments of the invention that refer to a display in this specification can also be realised as a printout (or other hardcopy) or as a computer file.

FIG. 5 illustrates a screen display 42 showing further or alternative output resulting from processing the captured image 100. In the example illustrated in FIG. 5, the required distance between the show-through line 60 and the front-side line 50 is set at 10500 micrometers whereas the image of the printed lines deviate from this by −70.870 micrometers. In this case the deviation (i.e. the error) is calculated from 10500−[Y3−Y2]=10500−[8418.96−(−2010.17)]=−70.870 where Y3 is the y-coordinate of the show-through horizontal line 60 and Y2 is the y-coordinate of the horizontal front side line 50. Although the desired separation was set at 10,500 micrometers (10.5 mm) in this example it will be appreciated that other desired separations may be set (eg 5, 6, 7, 8, 10, 12, 15 mm). Similarly, various thresholds for allowable deviations from the set separation may also be set.

Referring again to FIG. 3, at step S160 the printing parameters of the printer may be adjusted in response to the relative positions of the image features. For the particular result of image processing illustrated in FIG. 5 the relative positions of the show-through line 60 and the front-side line 50 give a separation that deviates from predetermined separation of 10500 microns by about 71 microns and, in this case, the separation is deemed to be within the required tolerances and no adjustment is required to the printing parameters. If adjustment was deemed necessary then the print parameters may, in one embodiment, be adjusted automatically by sending an appropriate signal to the printer. A user could also make the adjustment to the printing parameters after reading the measurement parameters and/or viewing the captured image 100 or a representation of the captured image 100′. It should be appreciated that automatic adjustment of the printing parameters can be achieved without any display step S150, i.e. without display of the measurement parameters and/or display of the image 100, 100′. In one example the adjustment is made automatically by a print controller, i.e. a processor that controls the print output.

In one embodiment of the invention, data extracted from the captured image (which contains captured image components of the front and back printed images) is used to adjust the positions of the front and/or back printed images in subsequent printing operations. For example, in future prints an image on the print medium may be shifted up or down and/or to one side. Such shifting can be applied to the front printed image or the back printed image or both. In some particular embodiments one or both of the printed images are shifted so that the printed image lines (or other markings/image portions supporting ink) of the front printed image do not overlap, (or overlap is reduced) with the show-through lines (or other image portions supporting ink) from the reverse printed image.

In some cases it may be possible to apply different transformations apart from translations to the front and/or back images to achieve a desired result (eg a result in terms of the relative positions of the front and back printed images in the plane of the print medium). For example a rotation could be applied to an image, say, for example, an image may be printed in landscape format rather than portrait format or vice versa. In another example an image or elements thereof may be resized. Of course, the nature of the printed product and the desired printed output may restrict what particular transformations may or may not be acceptable.

At step S170 an alarm and/or message may be generated if the error in the relative positions of the image features is at or above a predetermined level. Such an alarm may be a visible alarm, an audible alarm or both a visible alarm and an audible alarm. If a message is displayed this may be displayed on a printer screen, that is on a screen that is an integral part of the printer. In some embodiments the message may be displayed on a screen that is in communication with the printer (wired or wireless) via, for example, a communications network which may be a local network (such as an intranet) or the Internet. It will be appreciated that the message may take the form as a printout instead of, or as well as, a screen display. The message may contain either text and/or graphical elements. In some embodiments the message may take the form of an email or text message or may take the form of an error log that is stored on a microprocessor or computer or computer readable memory/storage device.

The use of an alarm/message at step S170 can, in some embodiments, be used instead of the display at S160 and/or the printer adjustment at step S160. In other embodiments step S170 can be used in conjunction with step S150 and/or step S160. Some of the combinations of steps S150, S160 and S170 are illustrated in FIG. 3 whilst, for clarity, other combinations are not illustrated. It should be noted that the steps S150, S160 and S170 illustrated do not necessarily have to be taken in the order illustrated, for example some of these steps may occur substantially simultaneously. Steps S150, S160 and S170 have been grouped together as a “response” step S155 to illustrate that any combination of some or all of the steps can be used.

Following response step S155 the process may either stop or return to the start S100 and a further image (or images) is captured following some trigger, predetermined event or after a predetermined time.

FIG. 6 is a flow diagram illustrating a particular example of processing according to embodiments of the invention. Not all of the steps illustrated in the flow diagram are required for all embodiments of the invention. The skilled person should also appreciate that some of the steps illustrated in FIG. 6 can be used in conjunction with the steps illustrated in FIG. 3 and vice versa.

At step S210 one or more images 100 are taken of the print medium 20. The print medium 20 may have lines printed on both the front side of the medium and on the opposite, reverse, side of the medium 20 and an image taken of the medium 20 may be similar to that illustrated in FIG. 2. The lines printed on the medium 20 may be lines printed specifically to aid the calibration of the printer (“calibration lines”) or they may be part of an image intended for some other purpose (“image lines”). In some cases the lines could be curved lines or other printed objects could be used. For example, a shape such as, for example, a square could be used and the position of edges of such a shape could be used for calibration.

At step S220 the captured image is processed to identify lines originating from the front side of the medium 20. If, at step S230, the lines are identified then the processing can continue to identify lines on the reverse side of the medium 20. Of course, the image processing can identify lines originating from the reverse side of the medium 20 before identifying lines originating from the front side of the medium 20—the order of this image processing is not important.

If at step S230 or step S250 it is determined that lines cannot be identified (either from the front side or the reverse side of the medium) then it is further determined, at step S290, whether correction is possible. Correction possibilities are generally dependent on printing machine parameters, for example, if the changes required to the positions of the printed element on the print medium are too large then the printing machine electronics and/or mechanics cannot perform the correction. If correction is possible then the processing returns to step S210 and one or more further images are taken. If correction is not possible then it is determined, at step S295, that a hardware problem exists.

At step S260, once lines have been identified on the image that originate from the front side and the reverse (opposite) side of the medium 20 then the relative position of the front lines relative to the reverse lines are determined. In one embodiment Cartesian coordinates are used and the difference between the x and/or y coordinates (ΔX and ΔY) of a front side line and a reverse side line are calculated. Other coordinate systems could also be used (eg polar coordinates). For horizontal lines only the difference in the Y coordinates (ΔY) are generally used whereas for vertical lines only the difference in the X coordinates (ΔX) are generally used. For diagonal lines, or for curved lines, a combination of x and y coordinates can be used.

At step S270 it is determined whether correction is necessary given the determined relative positions of the front and reverse lines. If correction is not necessary then the process has finished (step S280).

If, at step 270, it is determined that a correction is necessary and also, at step S290, it is determined that correction is not possible then it is identified that a hardware problem exits (step 295). The existence of a problem can be notified to a user by, for example, an alarm or message as previously described.

If, at step S290, it is determined that correction is possible then this can be notified to a user and/or the printer can be adjusted appropriately. The processing can then continue to the start of the processing so that monitoring of the alignment of the images printed on the front and reverse sides of the medium 20 can continue.

Adjustment to printing parameters can include delays of image application to the moving print medium, mechanical shift of image application mechanism relative to the print medium, mechanical shift of the medium holding/supporting system relative to the image application mechanism and so on.

Algorithms with the same or similar flow diagram illustrated in FIG. 6 could be used for statistical data accumulation and for diagnostics. For example if ΔX and/or ΔY on a sequence of prints have too big distortion(s) this may indicate that the mechanics of the printing machine are not stable and maintenance (such as, say, lubrication) is necessary.

In an embodiment of the invention the data that forms the print job that is executed by the printer may be adjusted as well as or instead of adjusting other printing parameters. In one example the data may be modified so as to shift the position of one or more elements printed on a particular side of the print medium, or to shift the position of one or more elements printed on both sides of the print medium. As described hereinbefore, other transformations apart from shifts/translations may be applied to the print data.

In one embodiment of the invention adjustment is made to the printer and/or print data so that the print on one side of the medium 20 does not overlap or substantially overlap with print from the reverse side of the medium 20. That is, adjustment is made so that the show-through from an image on the reverse side of the medium 20 does not impact on the visibility/clarity of the image on the front side of the medium 20. In one example the printed image on two sides of a sheet should not consist of overlapped vertical and horizontal lines. In some embodiments, for example where overlap cannot be prevented, the overlap is reduced, minimised or substantially minimised. The printer can therefore be controlled so as to position images printed on both front side and the reverse side of the print medium 20 whilst maintaining, increasing or maximising/substantially maximising the contrast of image lines (or other elements of the image) with the background of the printed image. The background of the image is the part of a side of a print medium that is not supporting print on that side. In this sense the show-through image from the reverse side of the medium 20 would form part of the background to the front side image and vice versa.

In some embodiments a threshold is set for the separation of the lines (or other elements) printed on the front and reverse sides of the print medium. If analysis of the captured image of the print medium 20 shows that the separation exceeds this predetermined threshold then the placement of further printed images can be adjusted. Following such adjustment a new image is printed and a further image of the print medium can be captured and the separation compared again with the predetermined separation.

FIG. 7 illustrates a system for capturing an image of a print medium 20 according to an embodiment of the invention. In this example the front side of the print medium is lit by lighting 30 which may be provided by, for example, one or more lamps directed at the front side of the medium 20. A camera 10 is positioned on the same side of the medium 20 as the lighting 30, this may be because, for example, that there is insufficient space or access to position the camera 10 on the opposite side of the medium 20 to the lighting 30. In an embodiment of the invention an image of the medium 20 is taken after the medium 20 is transported by a transport mechanism such as a substrate roller 28. The image taken by the camera 10 may be synchronised with the transportation of the medium 20 via a synchronisation signal 24. The synchronisation signal 24 may originate from the substrate roller 28 or some other part of the printer.

FIG. 8 illustrates a system for capturing an image of a print medium 20 according to a further embodiment of the invention. This embodiment is similar to the embodiment illustrated in FIG. 7 but with backlighting 32, that is, lighting is provided on the opposite side of the print medium 20 as the camera 10. The backlighting 32 may be provided as well as, or instead of, lighting 30 directed at the front side of the print medium 20.

In embodiments of the invention adjustment can be performed without taking the printed image outside of the printer. For example, images of the print medium are taken whilst the print medium is within the printer. In one embodiment, this can be achieved by placing a camera or other imager inside the printer. In one embodiment the camera/imager is outside the printer and one or more fibre optics 12 or other light guides are coupled to the camera/imager so that an image of the medium can be captured of the medium whilst the medium is being handled by the printer. Embodiments of the invention, therefore, allow adjustment of the printer/print data without stopping the print job. In some embodiments the adjustment process can be automated and the printer can be adjusted without intervention by the user.

Embodiments of the invention provide the possibility of making adjustments to the printer without stopping a printing operation since images can be captured of a print medium whilst the print medium is in the printer. This is in contrast to systems that halt the printing process to perform image analysis of the printer's output (i.e. off-line analysis) before adjusting the printer and resuming the printing operation.

FIG. 8 shows the relative position of imager 10 with respect to a printer 11, 11a illustrated with a dotted line. The imager 10 may be inside the printer (as illustrated with reference to printer 11) or connected to, or integral with, the printer (as illustrated with reference to printer 11a). The imager 10 is also shown connected to an optical fibre 12 (or other wave guide) so that an imager that is external to the printer 11, 11a can take images inside the printer 11, 11a. It should be appreciated that the arrangements of the imager relative to a printer illustrated in FIG. 8 can also be applied to the arrangements illustrated in FIG. 1 and FIG. 7.

FIG. 9 illustrates a system for capturing an image of a print medium 10 according to an embodiment of the invention. In this embodiment two (or more) images of the print medium 20 are taken using one or more imagers 10. One of the captured images can be used to determine the position of ink markings 16 supported on the front surface of the medium 20 (i.e. the face of the medium facing the imager 10) whilst another of the captured images can be used to determine the position of the ink.

Using one imager to image both sides of the printed medium simultaneously is more efficient and less expensive and takes up less space than having two imagers (i.e. using an imager for each side of the substrate) and obviates the need to register two separate captured images. Using a single imager also improves the ability to have the imager placed within the printer.

FIG. 9 illustrates a system for capturing images of a print medium 20 according to an embodiment of the invention. In this embodiment two (or more) images of the print medium 20 are taken using one or more imagers 10. One of the captured images can be used to determine the position of markings 16 (eg ink markings) supported on the front surface of the medium 20 (i.e. the face of the medium facing the imager 10) whilst another of the captured images can be used to determine the position of the markings 17 supported on the reverse face of the print medium 10. The image of the markings 17 supported on the reverse side of the print medium are obtained using show-through—that is the translucent properties of the print medium 10 allows light (or other imaging radiation) to travel through the material of print medium 20 and then be reflected back towards the imager 10. The embodiment of the invention illustrated in FIG. 9 demonstrates that it is possible to determine the relative positions of the ink markings on the front 16 and back 17 of the print medium 20, by imaging the print medium 20 from a single side, without necessarily capturing and/or analysing images of the markings 16 and 17 in a single image (eg captured in a single camera exposure).

In one arrangement two imagers 10 can be used in which a first image is taken of a section of the print medium 20 by a first imager and a second image is taken by a second imager of substantially the same section of the print medium 20 at a different point in the path of the print medium 20 through the printer. The position of the front-side markings 16 captured in, say, the first image by the first imager, can then be compared with the position of the reverse-side markings 17 captured in the second image by the second imager. The first imager may possibly be configured to have improved or optimised imaging of the front-side markings 16 whereas the second imager may possibly be configured to have improved or optimised imaging of the reverse-side markings 17. For example the first imager may use a shorter focal length than the second imager so that in the first image the front-side markings 16 have improved focus whereas in the second image the reverse-side markings 17 have improved focus.

As a variation on this technique one or more fibre optics (or, more generally, at least two optical paths) may couple a single imager 10 to the surface of the print medium 20 at two different positions above the path of the print medium 20 so that two different images of the same section of print may be taken at two different points in the path of the print medium 20 through the printer by the same imager 10. This variation also allows for the focal point of the two optical paths to be arranged to be different so as to bring into sharper focus either the front-side markings 16 or the reverse side markings 17 as required.

In one arrangement a single imager 10 can be used to capture two separate images at the same position on the path of the print medium through the printer. In this case the printer produces two substantially identical printed images (or image portions such, for example, reference marks) at different positions on the print medium 20 and the imager takes an image of each of these identical printed images when that printed image comes into the field of view of the imager 10.

For the various embodiments/arrangements described above with reference to FIG. 9, it is generally necessary to reference the position of the captured image used to determine the front-side markings 16 to the position of the captured image used to capture the reverse-side markings 17. Such a referencing technique may use the edge or edges of the print medium 20 as a reference line/point or some other marking or feature on the print medium 20 may be used. Referencing techniques may also rely on the timing of the image exposures relative to the speed of the print medium 20 as the print medium passes the line of sight of the imager(s). If two imagers 10 are used to obtain two separate images then the distance between the two imagers (or more precisely the distance between the imaging positions of the two imagers) can be set at a known value. The skilled man may envisage other referencing techniques that can be used so that the two (or more) captured images can be referenced to each other.

It should be appreciated that embodiments of the invention described and/or claimed in a particular category should also be taken to be disclosed in other categories. For example it should be appreciated that any particular alignment/calibration system can be utilised in a printer/printing system. Similarly, embodiments of the invention disclosed as methods can be realised as printers and/or alignment/calibration systems configured to perform such methods and vice versa. Embodiments of the invention disclosed as methods or apparatus should also be taken to be disclosed as computer media carrying computer programs for performing said methods or for configuring apparatus as apparatus according to an embodiment of the invention.

1. A method of printing on both sides of a substrate (20) comprising checking the relative positions of images on the front and back of the printed substrate (20) by capturing an image (100, 100′) of markings (60, 62, 50, 52) on the front and back by imaging the printed substrate (20) from one side only, the markings on the back (60, 62) of the printed substrate (20) being seen through the material of the substrate (20).

2. The method of claim 2, comprising adjusting relative positions of images on the front and back of the substrate (20) in a subsequent print operation if it is determined that the relative positions of the front (50,52) and back (60,62) markings are determined not to be acceptable.

3. The method of claim 2, wherein said adjusting comprises adjusting a printing control parameter in response to said comparison and/or altering print data used in said subsequent printing operation in response to said comparison.

4. The method of any previous claim, wherein the image (100) of the printed substrate (20) is obtained from the printed substrate (20) when the printed substrate (20) is being supported in a printer (11; 11a).

5. A method of image processing comprising:
capturing image data from an image on a front side of an image bearing substrate (20);
capturing show-through image data from an image on the back side of the image bearing substrate (20);
processing the captured data to determine the relative positions of the image on the front side of the image bearing substrate and the image on the back side of the image bearing substrate (20).

6. A method of controlling a printer (11; 11a) comprising: performing the image processing of claim 6; and controlling the printer (11; 11a) using said relative positions determined by the image processing.

7. A system for calibrating a printer (11; 11a) comprising: an imager (10) arranged to obtain an image (100) of a print medium (20) produced by the printer (11; 11a) from one side of the print medium; and a processor arranged to:
process said image (100) to determine a first image component (50,52) from a first side of the print medium (20) and a second image component (60, 62) from a second side of the print medium (20);
determine the relative separation of the first and second image components; and
calibrate the printer (11; 11a) in response to the relative separation of the first and second image components.

8. The system of claim 7, wherein the imager (100) is an optical camera directed at the first side of the print medium (20) and, optionally, the system comprises a light source (30; 32) and the light source is one of: (i) directed at the second side of the print medium; (ii) configured to produce a non-uniform light spectrum; and (iii) a combination of (i) and (ii).

9. A printer (11; 11a) comprising: the system of claim 7 or 8 and a transport mechanism (21; 28) arranged to engage and transport the print medium (20) through the printer (11; 11a); wherein the imager (10) is arranged to obtain an image of the print medium (20) whilst the print medium (20) is engaged by the transport mechanism (21; 28).

10. The printer (11; 11a) of claim 9 wherein the transport mechanism (21; 28) comprises an impression drum (21) and the imager (10) is arranged to obtain said image when the print medium (20) is supported by the impression drum and the printer (11; 11a) optionally comprises an impression medium covering the impression drum (21), wherein the impression medium is configured to reflect light directed at the print medium (20).
